(19) United States
(12) Patent Application Publication
(10) Pub. No.: US 2007/0211491 A1
(43) Pub. Date: Sep. 13, 2007

(54) Light source installation in back light unit

(75) Inventor: Fang-I Chou, Yangmei Taoyuan (TW)

Correspondence Address: TROXELL LAW OFFICE PLLC;SUITE 1404, 5205 LEESBURG PIKE, FALLS CHURCH, VA, 22041, US

(73) Assignee: K-Bridge Electronics Co., Ltd.

(21) Appl. No.: 11/497,415

(22) Filed: Aug. 2, 2006

(30) Foreign Application Priority Data
Mar. 8, 2006 (TW) 095203832

(51) Int. Cl. F21V 7/04

(52) U.S. Cl. 362/601

(57) ABSTRACT

A light source installation in back light unit to effectively shorten the area required for incorporation of wavelength from each of multiple LEDs is comprised of multiple LED units; each LED unit being comprised of multiple LEDs; multiple LED units being disposed on a locking member and each LED unit being disposed on a curved section formed by the locking member and further on the incident plane of the light guide plate in different directions; and light emitted from those multiple LED units being mixed to incorporate wave length from each LED into white light.

### BACKGROUND OF THE INVENTION

(a) Field of the Invention

The present invention is related to an art for the incorporation of wavelength of each light emitting diode (LED) in a back light unit, and more particularly, to a light source installation adapted in the back light unit that is in simple construction, allows easy assembly, and effectively shortens the area needed for the wavelength incorporation of each LED.

(b) Description of the Prior Art

Generally, the white light demonstrated by a back light unit is essentially achieved by incorporating wavelength of streams of light respectively emitted by Red, Green, and Blue LEDs. Since streams of light emitted by each single LED are eradiated at a given angle as illustrated in FIG. 1(A), streams of light from each LED 10 are incorporated to achieve mixing results. The resultant white light mixing area A is comparatively farther away from each LED 10 and diffusion film is used to cause streams of light from each LED 10 to be overlapped as expected for wavelength of streams of light from each LED are incorporated to achieve light mixing purpose.

When streams of light of each LED 10 pass through a diffusion film 20 as illustrated in FIG. 2, a single diffusion film could only create once diffusion to extend the incorporation range of light waves, i.e., the distance H1 between the light mixing area A and each LED 10 is comparatively farther. An improvement of the prior art takes advantage of increasing the number of the diffusion film to shorten the incorporation range of the light waves (or reduce the incorporation area of light waves) thus to reduce the cost of providing associate light guide device. However, in practice, the strict increase of the number of diffusion film to shorten the spacing of the incorporation range of light waves of LED is found with several drawbacks including the difficulties in securing relative positions among the diffusion films, more tedious and complicate in assembly process; and compromised applicability due to that all the diffusion films must be stacked up.

Alternatively, white LED 10 may be used to forthwith create display results of white light as illustrated in FIG. 1(B). However, since streams of light emitted from each single LED are eradiated at a given angle (approximately 120°), the area that streams of light emitted between two LEDs 10 is prevented from reaching will create dark belt area B to fail uniform display of the back light unit.

### SUMMARY OF THE INVENTION

The primary purpose of the present invention is to provide an improved structure of a light source installation applied in a back light unit to solve those defectives found with the prior art of incorporating wavelength of LED in the back light unit. To achieve the purpose, the light source installation includes multiple LEDs with each disposed on a reflective mast in different directions and the reflective mask is disposed on the edge of the incident plane of a light guide plate.

Wherein, those LED units disposed with each in different direction allow streams of light from each LED to achieve light mixing results for wavelength of each LED to be incorporated into white light, thus to effectively shorten the incorporation area of wavelength of each LED and facilitate upgrading the white light quality for the entire back light unit; and more particularly, the design of having disposed multiple LED units on the reflective mask reduces the quantity of members required in the incorporation of wavelength of each LED in the back light unit and simplify the assembly art of associate members.

### BRIEF DESCRIPTION OF THE DRAWINGS

FIGS. 1(A) and 1(B) are schematic views showing incorporation of wavelength of each and all LEDs of the prior art.

FIG. 2 is a schematic view showing a construction of the prior art using a single diffusion film as aid to the incorporation of wavelength from each light emitting object in its original color.

FIG. 3 is a schematic view showing a status of the layout of applying a light source installation in a back light unit of the present invention.

FIG. 4 is a perspective view showing layout of LED units in a reflective mask in the present invention.

FIGS. 5(A), 5(B), and 5(C) are schematic views showing a construction of layout of multiple LED units in the present invention.

FIG. 6 is a schematic view showing a construction of incorporation of wavelength from each LED in the present invention.

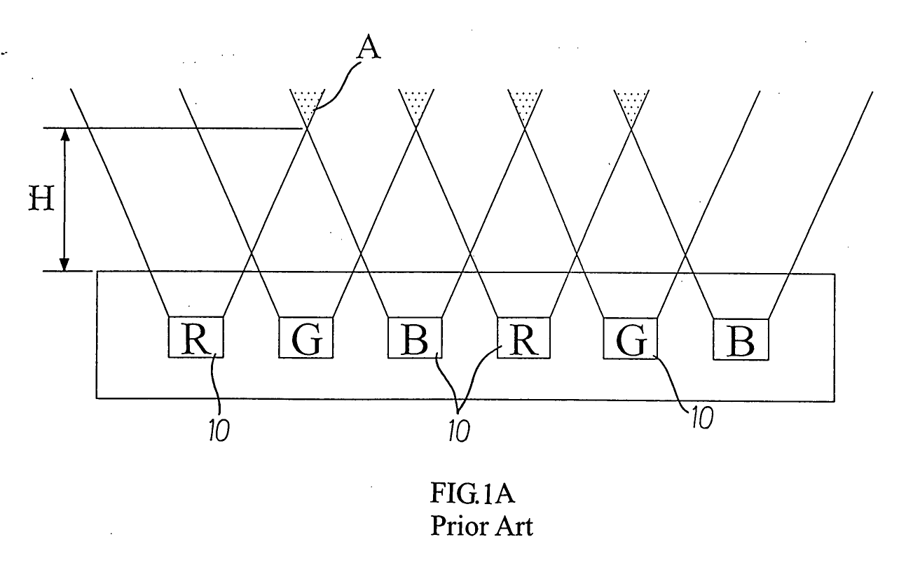

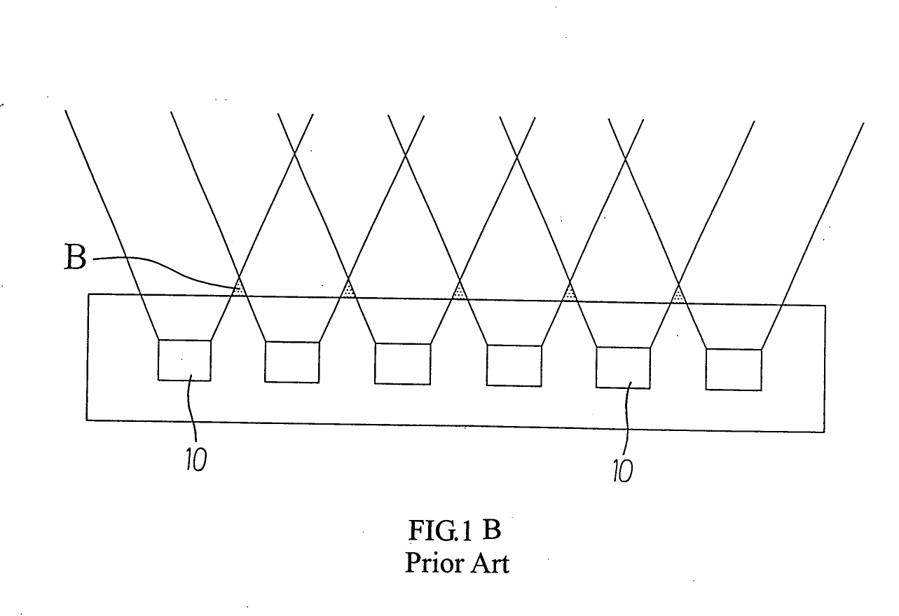

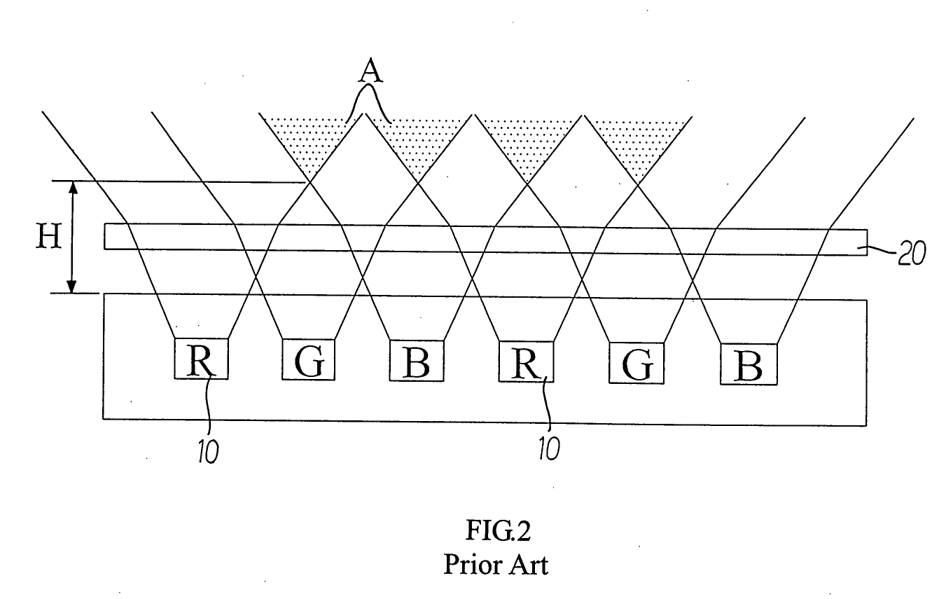

### DETAILED DESCRIPTION OF THE PREFERRED EMBODIMENTS

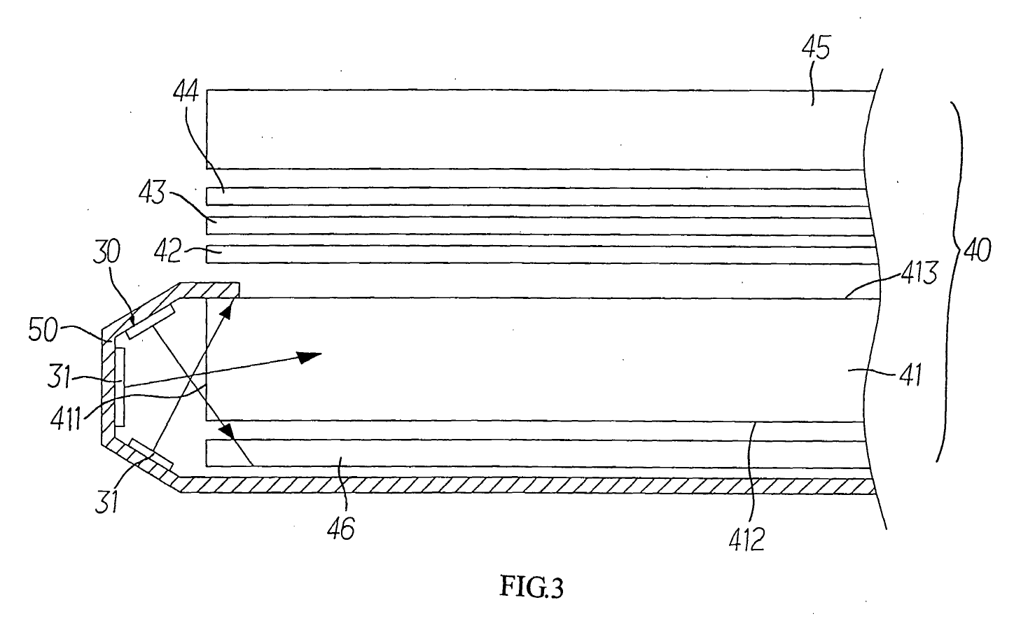

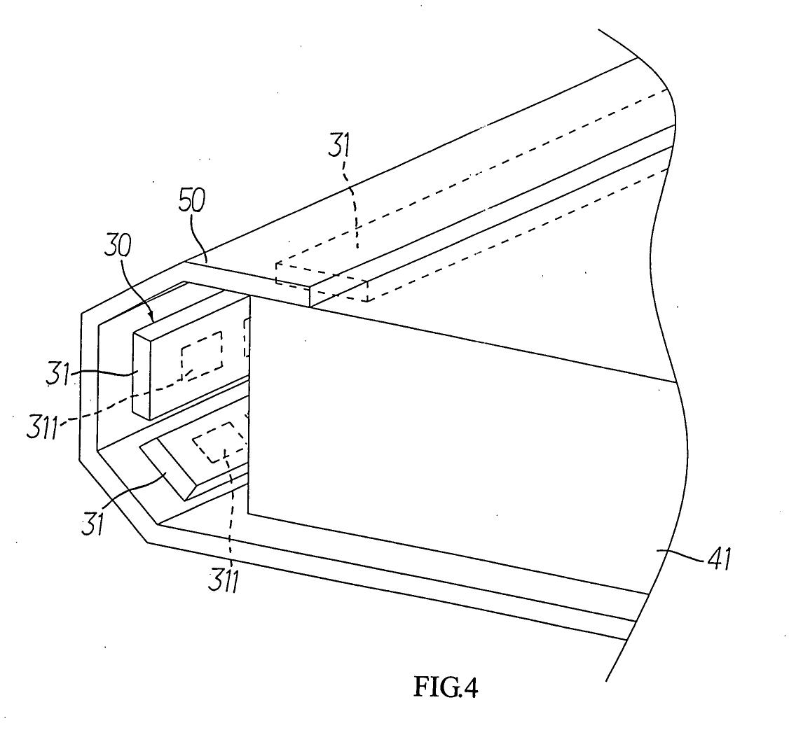

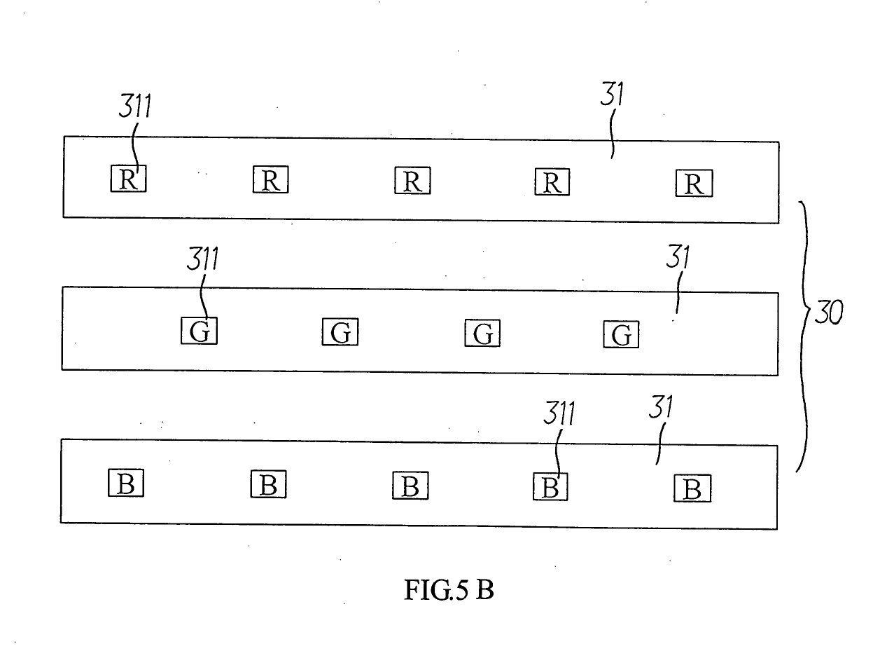

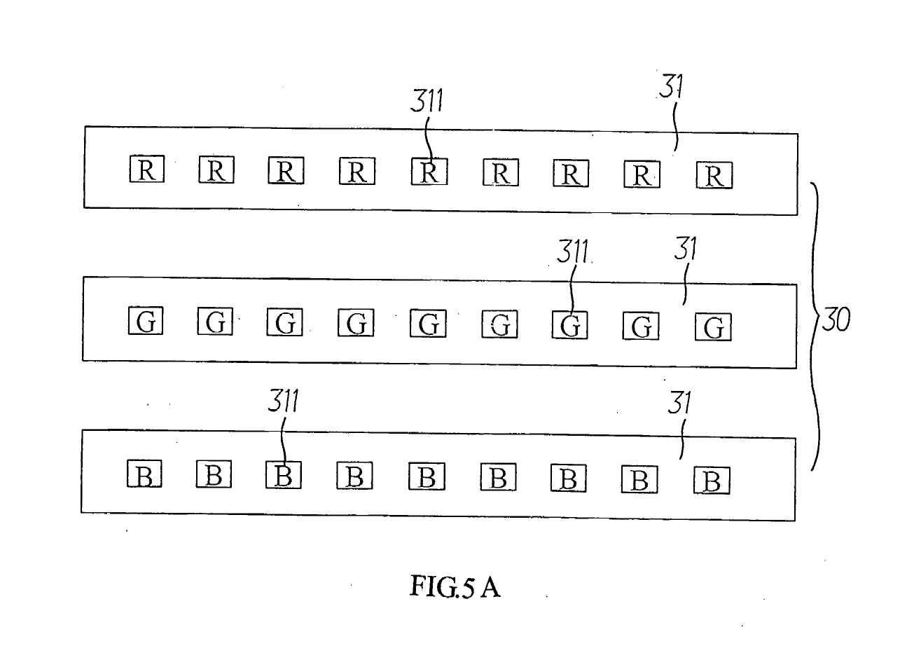

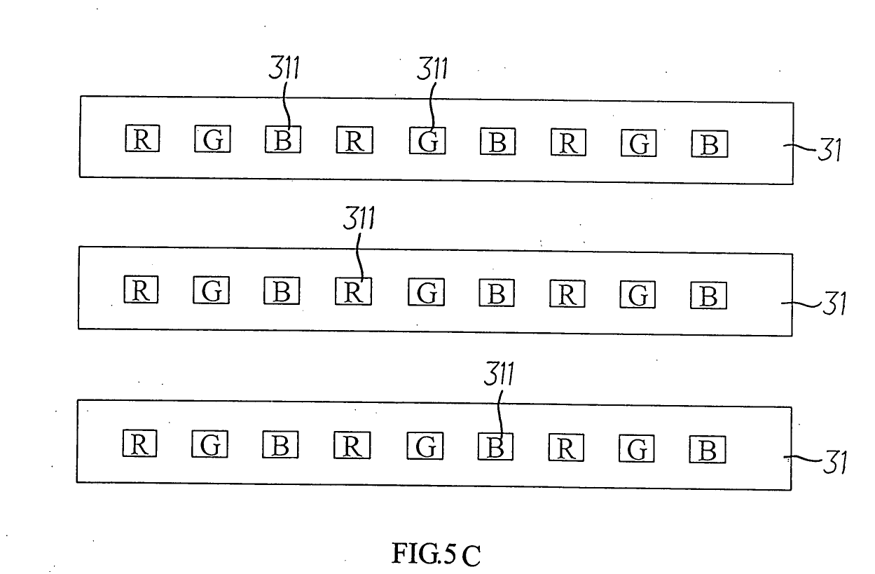

Referring to FIG. 3 for the basic construction and applied assembly method in practice of a light conductor in a light source installation for back light unit of the present invention, the light source installation of the present invention is essentially applied in the display effects of the back light unit. Wherein, the light source installation 30 is applied in a back light unit; the edge of a display panel assembly 40 of the back light unit is disposed with a reflective mask 50; and the light source installation 30 is adapted to a locking member (may be related to the reflective mask). In this preferred embodiment, the display panel assembly 40 includes a light guide plate 41, a lower diffusion film 42, a brightness enforcement film 43, an upper diffusion film 44, and a liquid crystal display (LCD) 45. The light guide plate 41 includes an incident plane 411, a base plane 412 crossing the incident plane 411, and an eradiation plane 413 in opposite to the base plane 412; a reflective film 46 is further disposed below the base plane 412 of the light guide plate. Streams of light emitted from the light source installation 30 enters into the light guide plate 41 through the incident plane 411 of the light guide plate 41 and eradiated towards the eradiation plane 413 of the light guide plate to achieve the display results by the LCD 60. Diffusion results are further increased to achieve uniform light emission of the light source through optical films including the lower diffusion film 42, the brightness enforcement film 43 and the upper diffusion film 44.

Wherein, the light source installation 30 includes multiple LED units 31 with each unit comprised of multiple LEDs 311 as illustrated in FIG. 4. The reflective mask 50 is formed with multiple curved sections with each LED unit 31 disposed on the curved section so that each LED unit 31 is provided on the reflective mask 50 in different direction. Multiple LED units 31 are disposed on three planes of the reflective mask 50 with those multiple LEDs 311 assigned to each LED unit 31 may be arranged in a pattern as respectively illustrated in FIGS. 5(A), 5(B), and 5(C), wherein an LED 311 of single color (red, green or blue) or mixed colors are construed into the LED unit 31; or multiple white light LEDs are forthwith provided to create white light display results.

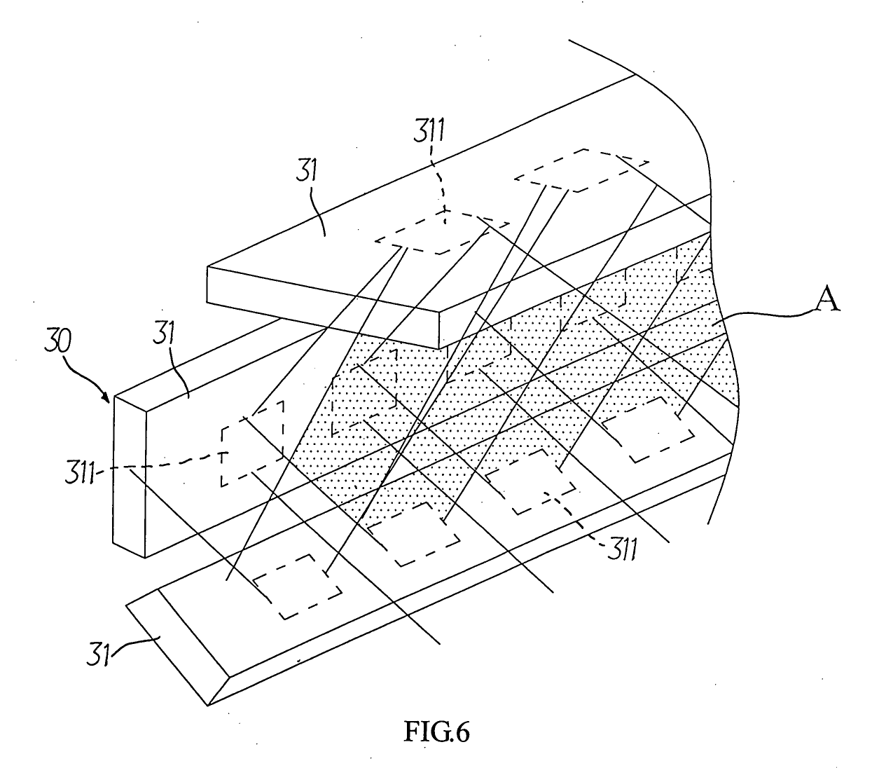

Accordingly, the advancing route of streams of light from each LED unit 31 before entering into the display panel assembly 40 as illustrated in FIG. 6 indicates that streams of light emitted from different direction by each LED 311 are mixed in a fashion different from that observed with the flat type of the prior art. In the present invention, streams of light emitted by LEDs 311 respectively in the direction of X, Y, and Z axles create a light mixing area A to allow the wavelength of each LED of original color to be incorporated into white light. Since the light mixing area A is closer to each LED 311, it can effectively eliminate a dark belt area B, thus to effective shorten the light mixing area for the incorporation of wavelength of each LED 311, effectively solve the problem of ripples found with the back light unit of the prior art, and facilitate upgrading the quality of white light for the entire back light unit.

Furthermore, the design of having multiple LED units disposed on the reflective mask reduces the number of members required for the incorporation of wavelength of each LED in the back light unit and simplifies the assembly art of associate members.

The prevent invention provides an improved structure of a light source to effectively shorten area required for the incorporation of wave length from each LED and upgrade white light quality of a back light unit, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A light source installation in back light unit to effectively shorten the area required for incorporation of wavelength from each of multiple LEDs is comprised of multiple LED units; each LED unit being comprised of multiple LEDs;
each LED unit being disposed in various directions on the incidence plane of a light guide plate; and wave length of each LED being incorporated into white light due to light mixing.

2. The light source installation in back light unit as claimed in claim 1, wherein the light source installation is adapted in a reflective mask.

3. The light source installation in back light unit as claimed in claim 1, wherein the light source installation is applied in a back light unit; a reflective mask being disposed on the edge of a display panel assembly of the back light unit;
and the light source installation being adapted in the reflective mask.

4. The light source installation in back light unit as claimed in claim 2, wherein those multiple LEDs are disposed on the reflective mask in different directions.

5. The light source installation in back light unit as claimed in claim 3, wherein those multiple LEDs are disposed on the reflective mask in different directions.

6. The light source installation in back light unit as claimed in claim 3, wherein the display panel assembly includes light guide plate, lower diffusion film, brightness enforcement film, upper diffusion film, and LCD panel.

7. The light source installation in back light unit as claimed in claim 1, wherein the light guide includes an incidence plane, a base plane crossing the incidence plane, and an emitting plan in opposite to the base plane.

8. The light source installation in back light unit as claimed in claim 4, wherein a reflective film is further disposed below the base plane of the light guide plate.

9. The light source installation in back light unit as claimed in claim 5, wherein a reflective film is further disposed below the base plane of the light guide plate.

10. A light source installation in back light unit to effectively shorten the area required for incorporation of wavelength from each of multiple LEDs is comprised of multiple LED units; each LED unit being comprised of multiple LEDs;
multiple LED units being disposed on a locking member and each LED unit being disposed on a curved section formed by the locking member and further on the incident plane of the light guide plate in different directions; and
light emitted from those multiple LED units being mixed to incorporate wave length from each LED into white light.

11. The light source installation in back light unit as claimed in claim 10, wherein the locking member related to a reflective mask.
